(19) United States
(12) Patent Application Publication
(10) Pub. No.: US 2026/0247039 A1
(43) Pub. Date: Aug. 20, 2026

(54) IMAGING APPARATUS, IMAGING METHOD, AND STORAGE MEDIUM

(71) Applicant: CANON KABUSHIKI KAISHA, Tokyo (JP)

(72) Inventor: SHUNSUKE KAWAHARA, Saitama (JP)

(21) Appl. No.: 19/447,355

(22) Filed: Jan. 13, 2026

(30) Foreign Application Priority Data
Feb. 18, 2025 (JP) 2025-023878

(51) Int. Cl. H04N 23/71; H04N 23/73; H04N 25/50

(52) U.S. Cl. CPC H04N 23/71; H04N 23/73; H04N 25/50

(57) ABSTRACT

An imaging apparatus includes an imaging device including a counter configured to count the number of photons incident on a photoelectric conversion element and an output unit configured to output information of the counted value of the counter and a predetermined determination time when the counted value reaches a predetermined threshold value in the determination time after the counter has started counting. The imaging apparatus calculates an intensity distribution of light incident on pixels on the basis of the information of the counted value and the determination time output from the output unit and controls the determination time on the basis of the intensity distribution of light.

### BACKGROUND

### Field of the Technology

The present disclosure relates to an imaging apparatus, an imaging method, and a storage medium.

### Description of the Related Art

In recent years, an imaging apparatus that performs photoelectric conversion by digitally counting the number of photons arriving at an avalanche photodiode (APD) and outputting the counted value from each pixel has been proposed.

In Japanese Unexamined Patent Publication No. 2021-19281, an imaging apparatus including an APD, a sensor that detects an avalanche current, a switch that is provided between the APD and the sensor, and a reset element that resets a node between the switch and the sensor by applying a predetermined potential to an input terminal of the switch is disclosed.

With the configuration according to Japanese Unexamined Patent Publication No. 2021-19281, by resetting the reset element at intervals of a predetermined period using a clock pulse, it is possible to curb power consumption of the imaging apparatus even when photons are incident on the APD at high frequencies. It is also possible to obtain accurate signal information in which linearity between the number of photons incident on the APD and the counted value of photons detected by the imaging apparatus is maintained.

In a plurality of exposure determination times shorter than a maximum exposure time, when the counted value corresponding to each exposure determination time reaches a predetermined threshold value, it is possible to reduce power consumption by stopping counting of the number of photons and calculating and using an estimated value of the counting.

Here, the estimated value of the counting is a counted value which is calculated from the counted value in an exposure determination time shorter than the maximum exposure time and which is obtained by predicting the number of photons on the basis of the assumption that the APD has been exposed in a length of the maximum exposure time.

In this way, by using a photoelectric conversion technique disclosed in Japanese Unexamined Patent Publication No. 2021-19281, it is possible to digitally count the number of photons without being affected by reading noise. Accordingly, it is possible to detect slight light in a dark place and to capture a video in which the dynamic range is secured to be very wide.

In Japanese Unexamined Patent Publication No. 2023-14831, a technique of performing mapping corresponding to an exposure time for each block and generating image data with a high dynamic range in an imaging apparatus that can set an exposure time for each block of an imaging device is disclosed.

However, in the imaging apparatus disclosed in Japanese Unexamined Patent Publication No. 2021-19281, since the imaging device can acquire data in which the dynamic range is secured to be very wide but a larger number of bits than the number of output bits of the imaging device is necessary, gradation of data output from the imaging device decreases.

In the imaging apparatus disclosed in Japanese Unexamined Patent Publication No. 2023-14381, since the exposure time cannot be controlled for each pixel of the imaging device, it is difficult to perform control in an optimal exposure time based on a light intensity incident on each pixel of the imaging device.

### SUMMARY

An imaging apparatus according to an embodiment of the present disclosure includes an imaging device including:
a counter configured to count the number of photons incident on a photoelectric conversion element; and
an output unit configured to output information of the counted value of the counter and a predetermined determination time when the counted value reaches a predetermined threshold value in the determination time after the counter has started counting;
wherein an intensity distribution of light incident on pixels is calculated on the basis of the information of the counted value and the determination time output from the output unit, and
wherein the determination time is controlled on the basis of the intensity distribution of light.

Further features of the present disclosure will become apparent from the following description of embodiments with reference to the attached drawings.

### BRIEF DESCRIPTION OF THE DRAWINGS

FIG. 1 is a diagram illustrating an example of a configuration of an imaging apparatus 100 according to a first embodiment.

FIG. 2 is a functional block diagram illustrating an example of a functional configuration of the imaging apparatus 100 according to the first embodiment.

FIG. 3 is a diagram illustrating an example of a configuration of an imaging device 102 according to the first embodiment.

FIG. 4 is a diagram illustrating an example of a configuration of a sensor board 31 according to the first embodiment.

FIG. 5 is a diagram illustrating an example of a configuration of a circuit board 33 according to the first embodiment.

FIG. 6 is a diagram illustrating an example of an equivalent circuit of a photoelectric conversion element 402 and a signal processing circuit 501 connected to the photoelectric conversion element 402 according to the first embodiment.

FIG. 7 is a diagram illustrating an example of a relationship between an operation of an APD and an output signal according to the first embodiment.

FIG. 8 is a timing diagram illustrating an example of an operation of a signal processing circuit 501 according to the first embodiment.

FIG. 9 is a diagram illustrating an example of a relationship between an exposure time and a counted value of a counter circuit 611 for each pixel 401 included in the imaging device 102 according to the first embodiment.

FIG. 10 is a diagram illustrating an example of exposure time information Tcode which is output on the basis of an exposure time when the counted value is greater than a count threshold value according to the first embodiment.

FIG. 11 is a diagram illustrating an example of a relationship between an exposure time and a counted value of a counter circuit 611 for each pixel 401 included in the imaging device 102 according to the first embodiment.

FIG. 12 is a diagram illustrating an example of the number of output signals for each exposure time with respect to the number of input signals according to the first embodiment.

FIG. 13 is a diagram illustrating an example of the number of output signals for each exposure time with respect to the number of input signals and the count threshold value according to the first embodiment.

FIG. 14 is a flowchart illustrating an example of a process flow of an imaging method in the imaging apparatus according to the first embodiment.

FIG. 15 is a diagram illustrating an example of a histogram after conversion of the number of output signals has been performed according to the first embodiment.

FIG. 16 is a flowchart illustrating an example of a process of Step S1405 in FIG. 14.

FIG. 17 is a diagram illustrating an example of a data range corresponding to an exposure determination time and a count threshold value according to the first embodiment.

FIGS. 18A and 18B are diagrams illustrating an example of a histogram when a pixel value is saturated and when a pixel value is not saturated according to the first embodiment.

FIGS. 19A and 19B are diagrams illustrating an example of a data range after each exposure determination time has been changed according to the first embodiment.

FIG. 20 is a diagram illustrating an example of table data of an exposure determination time corresponding to a count maximum value according to the first embodiment.

FIG. 21 is a flowchart illustrating an example of a process flow of an imaging method in an imaging apparatus according to a second embodiment.

FIG. 22 is a flowchart illustrating an example of a process of Step S2101 in FIG. 21.

FIGS. 23A and 23B are diagrams illustrating an example of a histogram when an image is black-crushed and when an image is not black-crushed according to the second embodiment.

FIG. 24 is a diagram illustrating an example of a histogram after a shutter speed has been changed according to the second embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

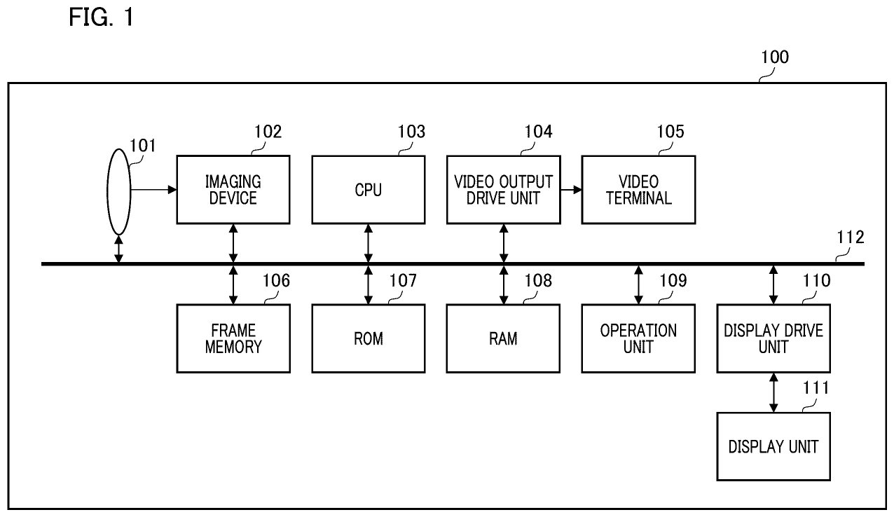

FIG. 1 is a diagram illustrating an example of a configuration of an imaging apparatus 100 according to a first embodiment. In FIG. 1, an optical lens 101, an imaging device 102, a CPU 103, a video output drive unit 104, a frame memory 106, a ROM 107, a RAM 108, an operation unit 109, and a display drive unit 110 are connected to an internal bus 112. The constituents connected to the internal bus 112 can transmit and receive data via the internal bus 112.

The optical lens 101 is an optical element including a lens and a motor for driving the lens or the like. The optical lens 101 operates on the basis of a control signal and can perform optical enlargement or reduction of a video or adjustment of a focal distance, an iris, or the like.

When it is intended to adjust an incident light intensity, the light intensity can be adjusted to achieve desired brightness by controlling an aperture area of an iris. Light passing through the lens is focused on the imaging device 102. The imaging device 102 includes a color filter or a microlens which is not illustrated for each pixel, and a photoelectric conversion element which will be described later is used to convert an optical image to an electrical signal.

The CPU 103 which is a computer controls the functions of the imaging apparatus 100 by executing a computer program stored in a memory. That is, for example, the CPU 103 controls imaging settings of the imaging apparatus 100 or performs various types of image processing on an image output from the imaging device 102. Details thereof will be described later.

The video output drive unit 104 outputs an image processed by the CPU 103 to the outside of the imaging apparatus 100 via a video terminal 105. The video terminal 105 is an interface for outputting a video which can be seen by a user, and the video in a real time can be displayed on an external motor or the like.

For example, a serial digital interface (SDI), high definition multimedia interface (HDMI (registered trademark)), or DisplayPort (registered trademark) can be used as the interface.

The frame memory 106 is a device that can temporarily store a video signal and read the video signal according to necessity. For example, a dual data rate 4-syhnchronous dynamic RAM (DDR4-SDRAM) is used as the frame memory.

The ROM 107 is a nonvolatile memory and stores a computer program for operating the CPU 103, various adjustment parameters, or the like. The computer program read from the ROM 107 is loaded to the RAM 108 which is volatile and is executed therein. The RAM 108 generally employs a memory with a lower rate and a lower capacity than those of the frame memory 106.

The operation unit 109 is mainly used for a user to change a setting menu of the imaging apparatus 100. The operation unit 109 may be operated using a physical interface such as a button, an analog key, or a switch, may be operated from an external device via a USB interface or the like, or may be operated using a WEB browser or the like via a network.

The display drive unit 110 displays an image processed by the CPU 103 on a display device of a display unit 111. The display unit 111 includes a display device which can be seen by a user and can display, for example, the image processed by the CPU 103 and the setting menu. The user can ascertain an operation status of the imaging apparatus 100 therefrom.

The display unit 111 includes a liquid crystal display (LCD) device or an organic electroluminescence (EL) device as the display device. The display unit 111 may also include a resistive-membrane or capacitance thin-film device which is called a touch panel.

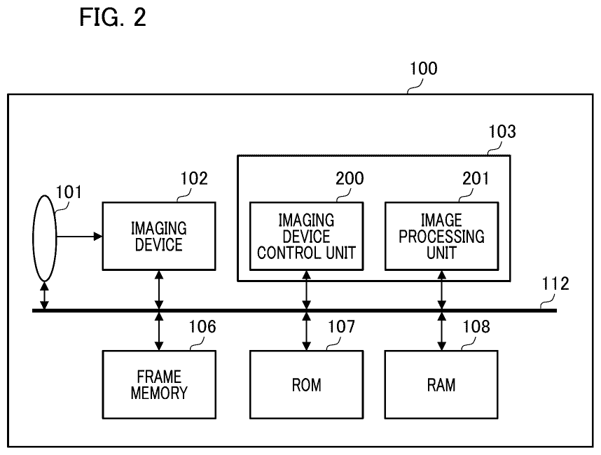

FIG. 2 is a functional block diagram illustrating an example of a functional configuration of the imaging apparatus 100 according to the first embodiment. Some of the functional blocks illustrated in FIG. 2 are realized by causing a CPU which is a computer included in the imaging apparatus or the like to execute a computer program stored in a memory which is a storage medium.

However, some or all thereof may be realized by hardware. An application-specific integrated circuit (ASIC), a processor (a reconfigurable processor, a DSP), or the like can be used as the hardware. The functional blocks illustrated in FIG. 2 may not be provided in the same housing and may be constituted by different devices connected to each other via signal lines.

In FIG. 2, the optical lens 101, the imaging device 102, and the CPU 103 are connected to the internal bus 112. An imaging device control unit 200 and an image processing unit 201 are provided as internal functions of the CPU 103. The imaging device control unit 200 transmits a control signal to the imaging device 102 to set settings associated with an exposure time of the imaging device such as an exposure time, an exposure determination time, and a count threshold value.

In the following description, exposure means charge accumulation, photoelectric conversion, or operations from start to end of imaging in the imaging device 102. In the present embodiment, charge accumulation, photoelectric conversion, and imaging are used in the same meaning, and the operations of charge accumulation, photoelectric conversion, and imaging include, for example, an operation of counting a photoelectrically converted signal using a counter when the imaging device 102 includes APDs.

The image processing unit 201 performs various types of image processing such as calculation of a histogram of an image, luminance correction such as gain correction, white balance correction, and color correction on an image captured by the imaging device 102.

The image processing unit 201 can generate a character string for notifying a user of a setting state or the like in the imaging apparatus 100 or a menu and overlap the generated character string or menu on an image. In addition to text information, imaging assist indications such as a histogram, a vector scope, a waveform monitor, a zebra, peaking, and a false color can also be overlapped.

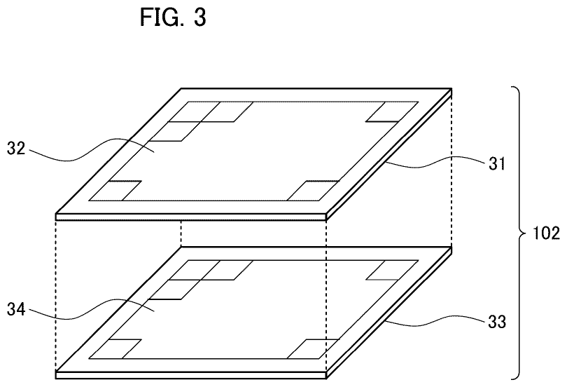

The imaging device 102 will be described below with reference to FIGS. 3 to 11. FIG. 3 is a diagram illustrating an example of a configuration of the imaging device 102 according to the first embodiment. As the imaging device 102, an imaging device with a so-called stacked structure which is configured by stacking two boards including a sensor board 31 and a circuit board 33 and electrically connecting the two boards will be exemplified. The circuit board 33 includes a circuit area 34 that processes a signal detected in a pixel area 32.

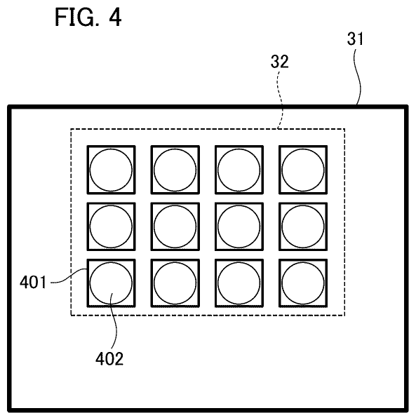

FIG. 4 is a diagram illustrating an example of a configuration of the sensor board 31 according to the first embodiment. A pixel area 32 of the sensor board 31 includes a plurality of pixels 401 which are two-dimensionally arranged in directions of a plurality of rows and columns. Each pixel 401 includes a photoelectric conversion element 402 including an APD. The number of rows and the number of columns of a pixel array constituting the pixel area 32 are not limited to the example illustrated in FIG. 4.

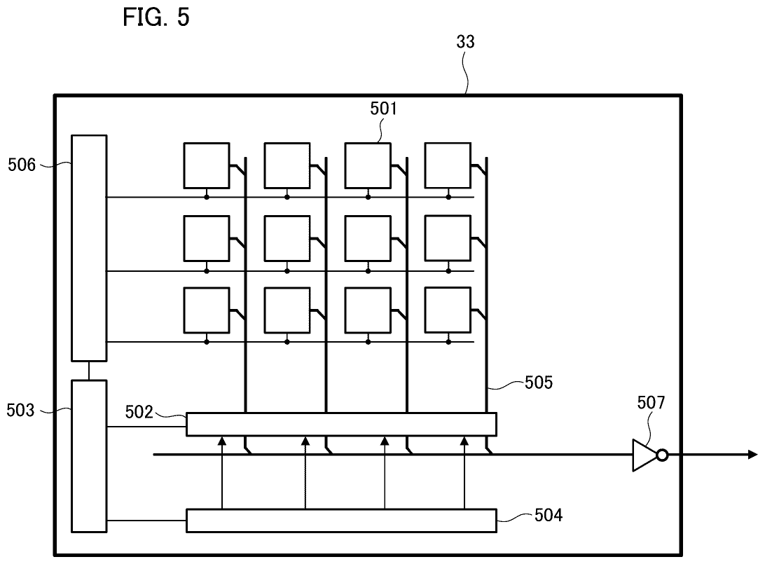

FIG. 5 is a diagram illustrating an example of a configuration of the circuit board 33 according to the first embodiment. The circuit board 33 includes a signal processing circuit 501 that processes electric charges photoelectrically converted by the corresponding photoelectric conversion element 402 in FIG. 4, a reading circuit 502, a control unit 503, a horizontal scanning circuit unit 504, a signal line 505, and a vertical scanning circuit unit 506. A signal output from the photoelectric conversion element 402 of a pixel 401 is processed by the corresponding signal processing circuit 501.

The signal processing circuit 501 is provided with a counter or the like, and a digital value acquired by counting the number of photons is stored in the counter. The horizontal scanning circuit unit 504 inputs a control pulse for sequentially selecting a column to the signal processing circuits 501 to read signals from the counters of the pixels storing a digital signal.

Signals from the signal processing circuits 501 of the pixels in the row selected by the vertical scanning circuit unit 506 are output to the signal line 505 for the column selected by the horizontal scanning circuit unit 504. The signals output to the signal line 505 are output to the outside of the imaging device 102 via an output circuit 507.

As illustrated in FIGS. 4 and 5, a plurality of signal processing circuits 501 are arranged in an area overlapping the pixel area 32 in a plan view. The vertical scanning circuit unit 506, the horizontal scanning circuit unit 504, the reading circuit 502, the output circuit 507, and the control unit 503 are arranged to overlap between an end of the sensor board 31 and an end of the pixel area 32 in a plan view.

These circuit units or control unit are a non-pixel area including no pixels 401, and the sensor board 31 includes the pixel area 32 and a non-pixel area disposed around the pixel area 32. The vertical scanning circuit unit 506, the horizontal scanning circuit unit 504, the reading circuit 502, the output circuit 507, and the control unit 503 are arranged in an area overlapping the non-pixel area in a plan view. The vertical scanning circuit unit 506 receives a control pulse supplied from the control unit 503 and supplies the control pulse to the pixels in the unit of a plurality of rows.

The vertical scanning circuit unit 506 includes a shift register or an address decoder and can perform high-speed reading by simultaneously reading a plurality of rows.

The imaging device according to the present embodiment is configured to count the number of photons incident on each APD and to output the counted value as a photoelectrically converted signal from the corresponding pixel. Accordingly, since time is required for the operation of a counter circuit that counts the number of photons, a plurality of rows are simultaneously read for the purpose of high-speed reading.

That is, the vertical scanning circuit unit 506 serving as a reading circuit that reads a pixel signal from a pixel simultaneously reads, for example, pixel signals from the pixels included in a first row and pixel signals from the pixels included in a second row.

The control unit 503 sets threshold value information serving as a determination reference and exposure time information indicating a timing of determination in a count determination circuit which will be described later.

Arrangement of the signal lines 505, arrangement of the reading circuit 502 and the output circuit 507, and the like are not limited to the example illustrated in FIG. 5. For example, the signal lines 505 may be disposed to extend in the row direction, and the reading circuit 502 may be disposed forward in the extending direction of the signal lines 505.

The function of the signal processing circuit 501 does not have to be provided for each photoelectric conversion element, but a configuration in which one signal processing circuit is shared by a plurality of photoelectric conversion elements and performs sequential signal processing thereon may be employed.

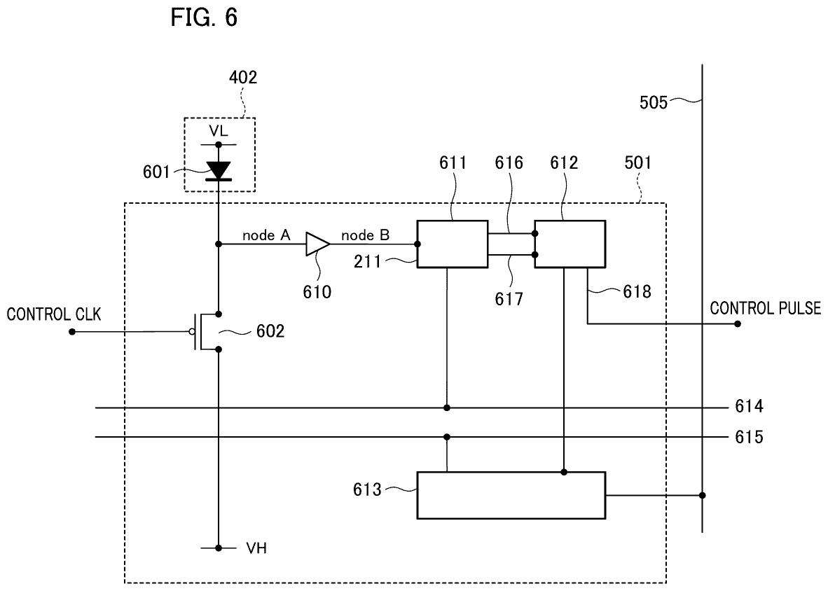

FIG. 6 is a diagram illustrating an example of an equivalent circuit of a photoelectric conversion element 402 and a signal processing circuit 501 connected to the photoelectric conversion element 402 according to the first embodiment. An APD 601 generates charge pairs corresponding to incident light through photoelectric conversion. One of two nodes of the APD 601 is connected to a power supply line for supplying a drive voltage VL (a first voltage).

The other of the two nodes of the APD 601 is connected to a power supply line for supplying a drive voltage VH (a second voltage) which is higher than the voltage VL via a quench element 602. In FIG. 6, the one node of the APD 601 is an anode, and the other node of the APD 601 is a cathode.

The anode and the cathode of the APD 601 are supplied with a reverse bias voltage for allowing the APD 601 to perform an avalanche multiplication operation. By supplying this reverse bias voltage, electric charge generated by incident light causes avalanche multiplication, and an avalanche current is generated.

The drive mode of the APD 601 is classified into two types of modes according to a value of the reverse bias voltage for operating the APD 601. The two types of modes include a Geiger mode in which a voltage difference between the anode and the cathode is greater than a breakdown voltage and a linear mode in which the voltage difference between the anode and the cathode is a voltage difference close to the breakdown voltage or equal to or less than the breakdown voltage.

The APD that operates in the Geiger mode is referred to as a single photon avalanche diode (SPAD). In an SPAD, for example, the drive voltage VL (the first voltage) is −30 V and the drive voltage VH (the second voltage) is 1 V.

The quench element 602 is connected to the power supply line for supplying the drive voltage VH and one of the anode and the cathode of the APD 601. The quench element 602 serves as a load circuit (a quench circuit) at the time of multiplication of a signal through avalanche multiplication and can perform a quench operation of curbing a voltage supplied to the APD 601 to curb the avalanche multiplication.

The quench element 602 can perform an operation (a recharge operation) of returning the voltage supplied to the APD 601 to the drive voltage VH by causing a current corresponding to a voltage drop due to the quench operation to flow therein.

The quench element 602 in the present embodiment is constituted by a MOS transistor, and ON and OFF of the quench element 602 are controlled by a control signal CLK supplied to the gate of the quench element. The control signal CLK is controlled by a signal generator in the control unit 503.

A waveform shaping unit 610 shapes a voltage change of the cathode of the APD 601 which is acquired when the APD 601 detects a photon and outputs a pulse signal. For example, an inverter circuit is used as the waveform shaping unit 610.

In the example illustrated in FIG. 6, one inverter is used as the waveform shaping unit 610, but a circuit in which a plurality of inverters are connected in series or another circuit with a waveform shaping effect may be used.

A counter circuit 611 counts the pulse signal output from the waveform shaping unit 610 and stores the counted value. When a control pulse RES is supplied via a drive line 614, the signal stored in the counter circuit 611 is reset.

The counter circuit 611 stops counting when a control pulse STOP is supplied from a counter determination circuit 612 via a drive line 617 and then maintains the counted value in the counter circuit 611 until the control pulse RES is supplied. The counter circuit 611 serves as a counter for counting the number of photons incident on the photoelectric conversion element.

The counter determination circuit 612 is supplied with the counted value stored in the counter circuit 611 via a drive line 616 and is supplied with a pulse signal form the control unit 503 via a drive line 618.

The counter determination circuit 612 compares the counted value with a predetermined threshold value at the timing at which a pulse signal has been received from the control unit 503. When the counted value is determined to be greater than the threshold value, the control pulse STOP is supplied to the counter circuit 611 via a drive line 617 to stop the counting.

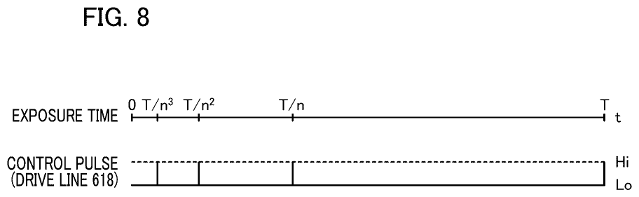

The determination result and the counted value at the timing at which the pulse signal has been received are output to a selection circuit 613. The timing diagram of the pulse signal will be described later with reference to FIG. 8.

When a control pulse SEL is supplied from the vertical scanning circuit unit 506 illustrated in FIG. 5 via a drive line 615 illustrated in FIG. 6 (not illustrated in FIG. 5), the selection circuit 613 electrically connects the counter determination circuit 612 and the signal line 505. Accordingly, an output signal from the counter determination circuit 612 of the corresponding pixel is output to the signal line 505. The selection circuit 613 includes, for example, a buffer circuit for outputting a signal. The selection circuit 613 serves as an output unit.

A switch such as a transistor may be provided between the quench element 602 and the APD 601 or between the photoelectric conversion element 402 and the signal processing circuit 501 to switch an electrical connection therebetween. Similarly, supply of the drive voltage VH or the drive voltage VL supplied to the photoelectric conversion element 402 may be electrically switched using a switch such as a transistor.

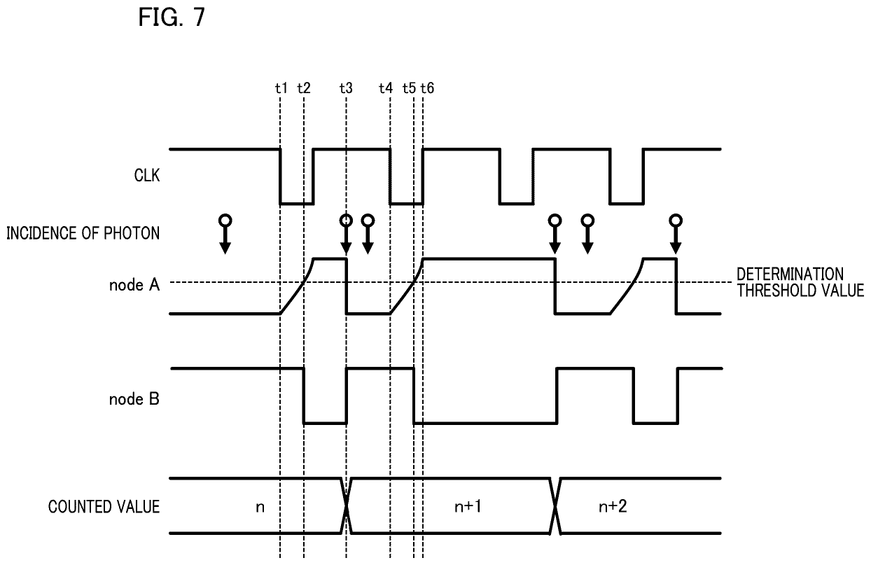

FIG. 7 is a diagram illustrating an example of a relationship between the operation of an APD and an output signal according to the first embodiment. FIG. 7 schematically illustrates a relationship between the control signal CLK of the switch, the voltage of a node nodeA which is an input end of the waveform shaping unit 610, the voltage of a node nodeB which is an output end, and the counted value in the counter circuit 611 in the signal processing circuit 501 illustrated in FIG. 6.

The switch in the present embodiment indicates the MOS transistor constituting the quench element 602 in FIG. 6. The drive voltage VH is not likely to be supplied to the APD 601 when the control signal CLK is at a high level, and the drive voltage VH is likely to be supplied to the APD 601 when the control signal CLK is at a low level.

The high level of the control signal CLK is, for example, 1 V, and the low level of the control signal CLK is, for example, 0 V. The switch is turned off when the control signal CLK is at the high level, and the switch is turned on when the control signal CLK is at the low level.

A resistance value of the switch when the control signal CLK is at the high level is higher than a resistance value of the switch when the control signal CLK is at the low level. When the control signal CLK is at the high level, the APD 601 is not likely to perform the recharge operation even if avalanche multiplication occurs, and thus the voltage supplied to the APD 601 is equal to or less than the breakdown voltage of the APD 601.

Accordingly, the avalanche multiplication operation in the APD 601 stops. At time t1, the control signal CLK changes from the high level to the low level, the switch is turned on, and the recharge operation of the APD 601 starts.

Accordingly, the voltage of the cathode of the APD 601 changes to a high level. The APD 601 can perform avalanche multiplication due to a difference in voltage between the anode and the cathode of the APD 601.

The voltage of the cathode is the same as the voltage of the node nodeA. Thereafter, when the voltage of the cathode changes from the low level to the high level, the voltage of the node nodeA at time t2 is equal to or greater than a determination threshold value.

Here, the determination threshold value is a voltage value which is uniquely determined according to electrical characteristics of the waveform shaping unit 610. At this time, a pulse signal output from the node nodeB is inverted and changes from the high level to the low level.

When the recharge operation is completed, a voltage (drive voltage VH-drive voltage VL) is applied to the APD 601. Thereafter, between time t2 and time t3, the control signal CLK changes to the high level, and the switch is turned off.

Then, at time t3, when photons are incident on the APD 601, avalanche multiplication occurs in the APD 601, an avalanche multiplication current flows in the quench element 602, and the voltage of the cathode drops. That is, the voltage of the node nodeA drops.

When the voltage of the node nodeA is lower than the determination threshold value while the voltage of the node nodeA is dropping, the voltage of the node nodeB changes from the low level to the high level. That is, a part of an output waveform in the node nodeA greater than a predetermined determination threshold value is shaped by the waveform shaping unit 610 and is output as a signal from the node nodeB.

The signal is counted by the counter circuit 611, and the counted value of the counter signal output from the counter circuit 611 increases by 1 LSB.

Between time t3 and time t4, photons are incident on the APD 601, but since the switch is turned off and the voltage supplied to the APD 601 does not reach the voltage difference at which avalanche multiplication is possible, the voltage level of the node nodeA is not greater than the determination threshold value.

At time t4, the control signal CLK changes from the high level to the low level, and the switch is turned on. Accordingly, a current for complementing the voltage drop from the drive voltage VL flows in the node nodeA, and the voltage of the node nodeA changes to the original voltage level. At this time, at time t5, the voltage of the node nodeA becomes equal to or greater than the determination threshold value, and thus the pulse signal of the node nodeB is inverted and changes from the high level to the low level.

At time t6, the node nodeA is statically determinate at the original voltage level, and the control signal CLK changes from the low level to the high level. In principle, a period in which the control signal CLK is at the low level has only to be longer than a period in which the voltage of the node nodeA changes from the low level to the high level.

In FIG. 7, the period in which the control signal CLK is at the low level is set to be equal to the period in which the voltage of the node nodeA changes from the low level to the high level. Accordingly, since the frequency of the control signal CLK can be set to be high, it is possible to reduce an influence of a “nonlinear relationship of the number of output signals with respect to the number of input signals” which will be described later.

Thereafter, as described above at time t1 to time t6, the voltages of the nodes, the signal lines, and the like change according to incidence of the control signal COK or photons. Here, when the recharge frequency of the APD is controlled using the control signal CLK, the relationship of the number of output signals with respect to the number of input signals is not linear.

In this case, the number of input signals is the number of photons incident on the APD and corresponds to the counted value of photons detected by the imaging apparatus. In the SPAD, when avalanche breakdown occurs, secondary photons are emitted to cause luminescent crosstalk to neighboring pixels. On the other hand, when an influence of the luminescent crosstalk is ignored, the relationship of the number of output signals with respect to the number of input signals can be theoretically derived.

Specifically, when the number of input signals is defined as Nph, the number of output signals is defined as Nct, the frequency (the number of CLKs per unit time) of the control signal CLK is defined as f, and the length of an exposure time is defined as T, the relationship is described as Expression 1.

$$Nct = fT ( 1 - {e}^{- \frac{Nph}{fT}} ) \qquad ( Expression 1 )$$

FIG. 8 is a timing diagram illustrating an example of the operation of the signal processing circuit 501 according to the first embodiment. The exposure time of each pixel is set to a predetermined exposure time which is T/n^{(m-1)} by the control unit 503. T is a maximum exposure time (a shutter speed) corresponding to one frame.

The exposure time used to determine the count threshold value is defined as an exposure determination time. Here, m is an arbitrary integer satisfying m≥1, and a timing diagram when m is set to satisfy 1≤m≤4 is illustrated in FIG. 8.

The drive line 618 is supplied with a control pulse which is at the high level in only the exposure time determined as t=T/n^{(m-1)}. When the counted value of the counter circuit 611 reaches a predetermined count threshold value in four exposure times T/n^{(m-1)} where m=1, 2, 3, 4, the APD 601 is switched from the Geiger mode to the linear mode, and the APD 601 is changed to a stop state.

When the APD 601 is in the stop state, a pulse signal is not output from the waveform shaping unit 610, and the counted value of the counter circuit 611 is maintained without any change. T/n^{(m-1)} indicating the exposure time corresponding to the control pulse and the counted value are output from the counter determination circuit 612 to the selection circuit 613.

Here, the predetermined exposure times are described to be T/n^{(m-1)}, but the exposure time may be set to predetermined different exposure times with a relationship different therefrom. For example, the exposure time may be set to T, T/L, T/M, and T/N using arbitrary numbers L, M, and N greater than 1 and satisfying L<M<N. The number of predetermined exposure times is described to be 4, but the number of predetermined exposure times may not be 4.

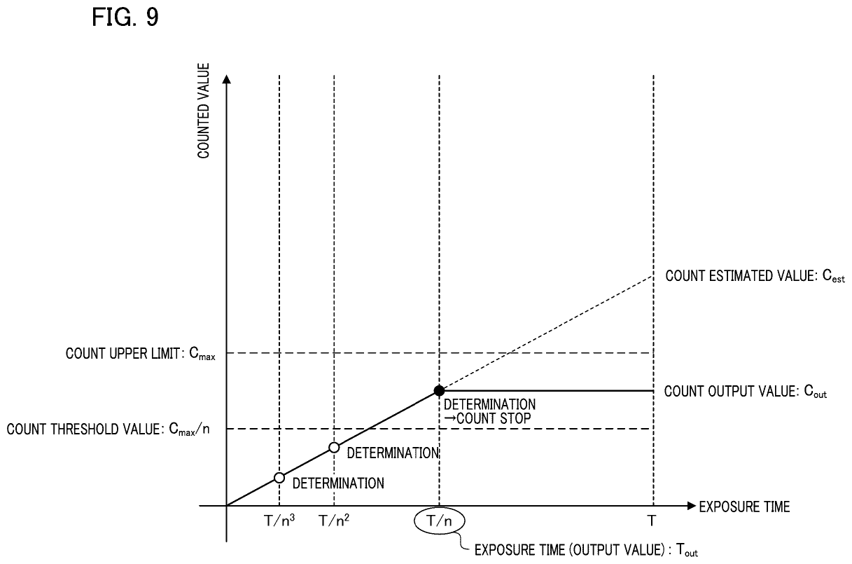

FIG. 9 is a diagram illustrating an example of a relationship between the exposure time and the counted value of the counter circuit 611 for each pixel 401 included in the imaging device 102 according to the first embodiment. In FIG. 9, similarly to FIG. 8, the control unit 503 sets the predetermined exposure times T/n^{(m-1)} satisfying 1≤m≤4.

When the count upper limit of the counter circuit 611 is defined as Cmax, the count threshold value is set to Cmax/n for the following reasons. In FIG. 9, it is assumed that a counted value of a certain pixel increases in proportion to time.

As described above with reference to FIG. 8, the counter determination circuit 612 determines whether the counted value is greater than the count threshold value in the times of T/n^{(m-1)} in the ascending order of the exposure times. When the counted value increases as illustrated in FIG. 9, it is determined that the counted value is not greater than the count threshold value in the times of T/n³ and T/n² and is greater than the count threshold value in the time of T/n.

At this time, the counting is stopped in the time of T/n, and the counted value Cout in the time of T/n and the exposure time T/n are output from the imaging device 102. The selection circuit 613 serves as an output unit configured to output information of the counted value and the predetermined determination time when the counted value of the counter reaches a predetermined threshold value in the determination time after the counter has started counting.

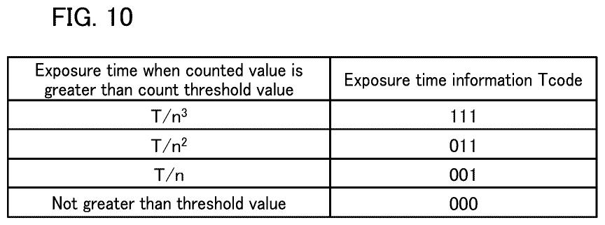

At this time, the exposure time T/n may be output as time information without any change, and it is preferable to determine exposure time information Tcode which is output according to the exposure time when the counted value is greater than the count threshold value as illustrated in FIG. 10.

When the predetermined exposure times do not satisfy the relationship of T/n^{(m-1)}, different count threshold values may be set depending on the predetermined exposure times.

FIG. 10 is a diagram illustrating an example of the exposure time information Tcode which is output on the basis of the exposure time when the counted value is greater than a count threshold value according to the first embodiment. The exposure time information Tcode illustrated in FIG. 10 is an example of a data format to be output.

The count estimated value Cest illustrated in FIG. 9 is calculated as Cest=Cout×n on the basis of the premise that the counted values increase at the same rate of increase in the exposure times 0 to T/n and the non-exposure times T/n to T.

The count estimation according to the present embodiment is based on the premise that that the counted values increase at the same rate of increase in the exposure times 0 to T/n and the non-exposure times T/n to T as described above. Accordingly, when the counted value reaches the count upper limit Cmax before reaching the count threshold value, the rate of increase in the exposure times 0 to T/n are not correctly predicted, and count estimation accuracy decreases.

Accordingly, in the count estimation according to the present embodiment, the threshold value is determined before the counted value reaches the count upper limit Cmax in order to maintain count estimation accuracy. As described above, when the recharge frequency of the APD is controlled using the control signal CLK, the relationship of the number of output signals with respect to the number of input signals is not linear, and thus linearity correction needs to be performed in order to enhance accuracy of the count estimated value Cest thereafter.

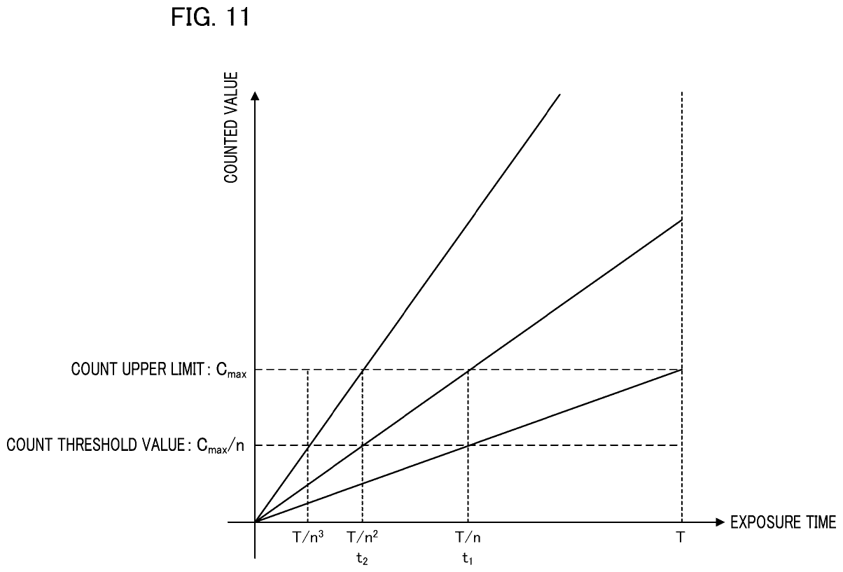

FIG. 11 is a diagram illustrating an example of a relationship between an exposure time and a counted value of the counter circuit 611 for each pixel 401 included in the imaging device 102 according to the first embodiment. The straight line in the graph represents an example of a count increase when the counted value becomes equal to the count threshold value in each exposure time in which threshold value determination is performed.

As described above, in the present embodiment, threshold value determination is performed before the counted value reaches the count upper limit Cmax in order to maintain the count estimation accuracy. Accordingly, the timing of threshold value determination when the counted value increases at a rate of increase at which the counted value reaches Cmax in the maximum exposure time T is defined as t1. The timing of threshold value determination when the counted value increases at a rate of increase at which the counted value reaches Cmax at the timing t1 is defined as t2.

That is, when the count threshold value is set to Cmax/n, the time until the counted value reaches Cmax/n when the counted value increases at the rate of increase at which the counted value reaches Cmax at the timing of the maximum exposure time T is calculated as T×(1/n), and thus t1=T/n is determined. Similarly, t2=t1×(1/n)=T/n² is determined. In this way, the exposure times in which threshold value determination is performed are calculated as T/n^{(m-1)}.

On the other hand, when the recharge frequency of the APD is controlled using the control signal CLK as illustrated in FIG. 6, the relationship of the number of output signals with respect to the number of input signals is not linear as expressed by Expression 1. Accordingly, linearity correction is performed on the basis of the count estimated value Cest calculated by the signal processing circuit 501.

In the present embodiment, when linearity correction is performed, the number of input signals Nph is calculated from the number of output signals Nct per exposure time using Expression 2 where f is the frequency (the number of CLKs per unit time) of the control signal CLK and T is the length of an exposure time.

$$Nph = - fT \times ln ( \frac{1 - Nct}{fT} ) \qquad ( Expression 2 )$$

The number of input signals Nph derived using Expression 2 is the number of photons per exposure time in which threshold value determination is performed. Accordingly, the number of photons in the exposure time of one frame is calculated as

$$Nph \times ( {n}^{( m - 1 )} ) .$$

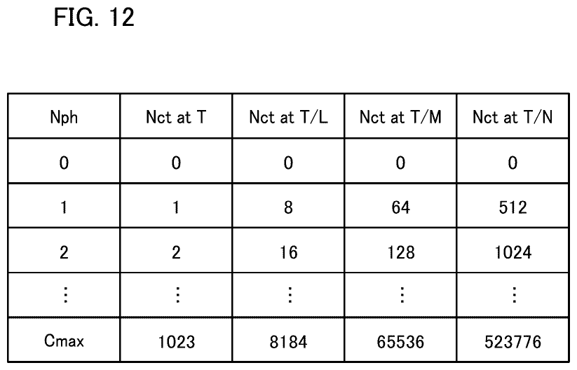

FIG. 12 is a diagram illustrating an example of the number of output signals for each exposure time with respect to the number of input signals according to the first embodiment. An influence of setting of the exposure determination time on the dynamic range and the gradation will be described with reference to FIG. 12. The maximum exposure time is T, the exposure determination times are T/L, T/M, and T/N, and the count maximum value is Cmax.

It is assumed that L, M, and N are arbitrary numbers greater than 1 and satisfying L<M<N. When conversion based on Expression 1 is performed for each exposure time and each exposure determination time, the number of output signals Nct corresponding to the number of input signals Nph is the same as illustrated in FIG. 12.

First, the dynamic range is determined using the maximum value of the number of output signals Nct. The dynamic range becomes wider as the maximum value of the number of output signals Nct becomes larger. That is, in FIG. 12, when the number of output signals Nct is the maximum value, the number of input signals Nph is Cmax and the exposure time is the minimum exposure time T/N.

Since Cmax is fixed depending on specifications of the counter of the imaging device, the value of Nct becomes larger and a wider dynamic range can be secured as the exposure determination time is set to a shorter time (as N becomes larger).

Then, the gradation is determined from a change of the number of output signals Nct corresponding to a change of the number of input signals Nph. The gradation becomes higher as the change of the number of output signals Nct becomes smaller. That is, the gradation becomes higher in the order of T, T/L, T/M, and T/N in FIG. 12.

Here, as the exposure determination time is set to a longer time, the gradation becomes higher. That is, it is preferable to set the exposure determination time such that the dynamic range of a subject is secured to be as long as possible and a decrease in gradation is prevented.

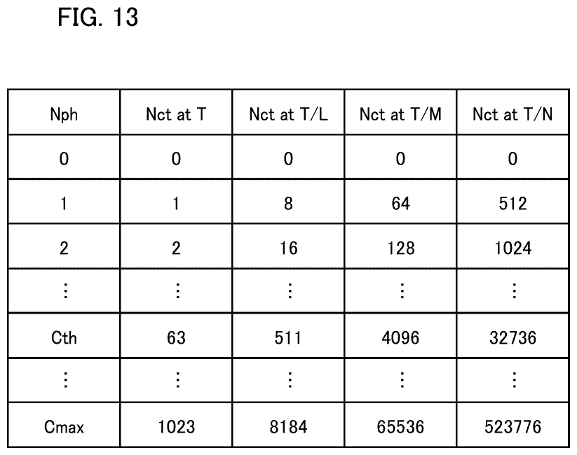

FIG. 13 is a diagram illustrating an example of the number of output signals for each exposure time with respect to the number of input signals and the count threshold value according to the first embodiment. An influence of setting of the count threshold value on the dynamic range and the gradation for each exposure determination time, for example, when the count threshold value is Cth will be described with reference to FIG. 13.

The dynamic range for each exposure determination time is determined from a difference between the number of output signals Nct at the count threshold value Cth and the number of output signals Nct at the count maximum value Cmax.

For example, in FIG. 13, the dynamic range is a difference between 32736 and 523776 at T/N and is a difference between 4096 and 65536 at T/M. However, when data ranges which can be acquired in different exposure determination times overlap as illustrated in FIG. 13, the exposure determination time is determined at a time point at which the counted value becomes greater than the count threshold value Cth, and thus the shorter exposure determination time is used as the exposure time.

That is, in FIG. 13, since the exposure time of pixels included in a data range overlapping data at T/M and T/N out of data which can be taken at T/M is T/N and is shorter than the exposure time T/M of pixels included in the non-overlapping data ranges, the gradation decreases. That is, it is preferable to set the count threshold value to a value with which the data ranges acquirable for the exposure determination times do not overlap.

Accordingly, it is preferable to calculate a light intensity range which can be acquired for each determination time on the basis of the determination times and the predetermined threshold values and to calculate a threshold value such that the light intensity ranges for the determination times do not overlap on the basis of the determination times and the light intensity ranges.

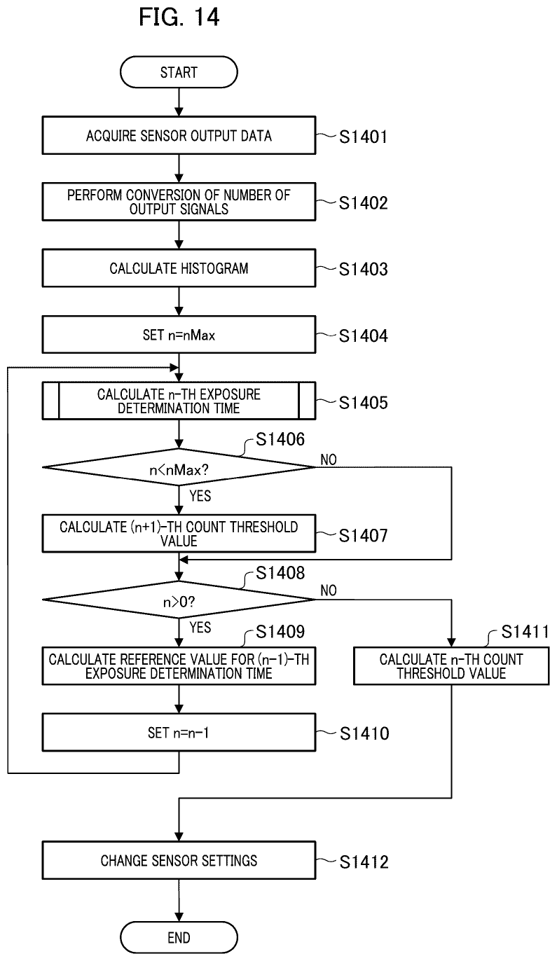

Process flows of controlling the exposure determination time in which the threshold value of the imaging device 102 based on a histogram of a subject is determined and the count threshold value that are performed by the imaging apparatus 100 according to the present embodiment will be described below with reference to FIGS. 14 to 20.

FIG. 14 is a flowchart illustrating an example of a process flow of an imaging method in the imaging apparatus according to the first embodiment. The operations of the steps in the flowchart illustrated in FIG. 14 are sequentially performed by causing the CPU 103 which is a computer in the imaging apparatus to execute a computer program stored in a memory. The process flow illustrated in FIG. 14 is started and repeatedly performed after the imaging apparatus 100 has started.

In the flowchart illustrated in FIG. 14, first, sensor output data is acquired in Step S1401. That is, the image processing unit 201 acquires output data from the imaging device 102 and stores the output data in the frame memory 106 or the RAM 108.

The acquired output data is data including information of the number of input signals Nph which is the counted value and the exposure time information Tcode which is the determination time for each pixel. For example, combined data of 14 bits in which 11 bits of the number of input signals Nph and 3 bits of the exposure time information Tcode are combined is acquired. That is, the output unit outputs information on the counted value and the determination time as combined data for each pixel.

Then, in Step S1402, the image processing unit 201 converts the data acquired in Step S1401 to the number of output signals. Thereafter, in the present embodiment, for example, it is assumed that the shutter speed (the maximum exposure time) is T and the exposure determination times are T/L, T/M, and T/N (where L<M<N).

Specifically, first, the exposure time information Tcode for each pixel is converted to one exposure time of T, T/L, T/M and T/N. Then, data of the number of output signals Nct corresponding to the number of input signals Nph and the exposure times is acquired as illustrated in FIG. 12 by converting the number of output signals to Nct using Expression 1 based on the number of input signals Nph and the exposure times. For example, the number of output signals Nct is data in which a very wide dynamic range of 20 bits is secured.

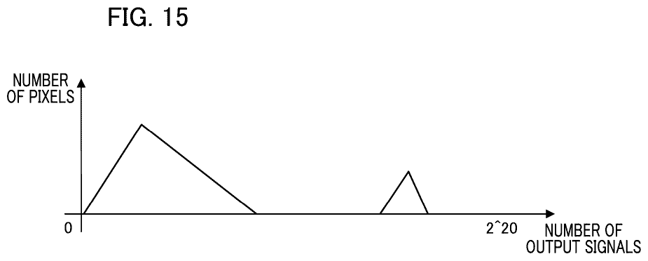

Then, in Step S1403, the image processing unit 201 calculates a histogram of data in which linearity has been corrected. FIG. 15 is a diagram illustrating an example of a histogram after conversion of the number of output signals according to the first embodiment, where the horizontal axis represents the number of output signals and the vertical axis presents the number of pixels. Here, Step S1403 serves as a calculation step (a calculation unit) of calculating an intensity distribution of light incident on pixels on the basis of the counted value and the determination result.

Then, in Step S1404, the CPU 103 sets a variable n to nMax which is a maximum value of n. Here, the maximum value of n is defined as a value obtained by subtracting 1 from the number of exposure determination times. In the present embodiment, it is assumed that the number of exposure determination times is 3, nMax is 2, a zeroth exposure determination time is T/L, a first exposure determination time is T/M, and a second exposure determination time is T/N.

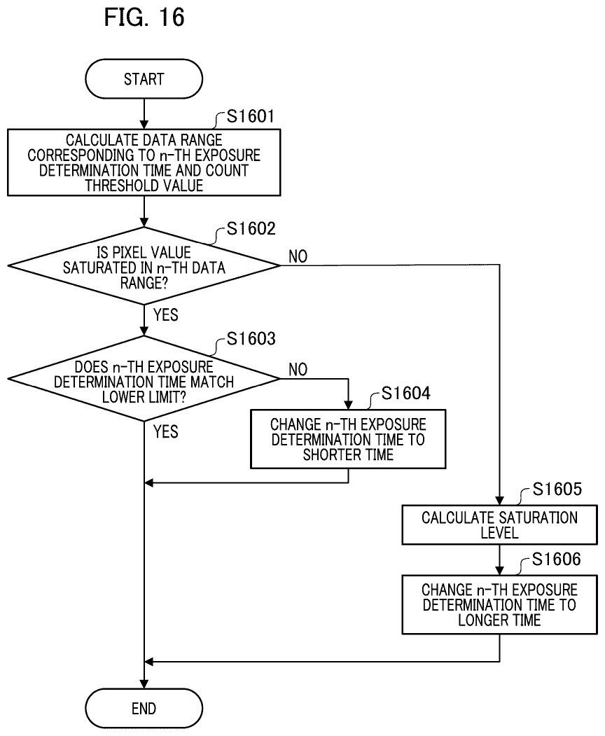

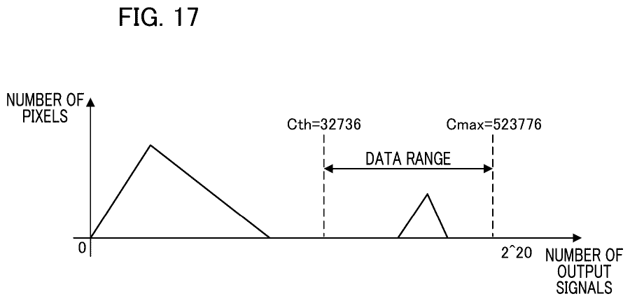

Then, in Step S1405, the n-th exposure determination time is calculated. Here, Step S1405 will be described with reference to FIGS. 16 and 17.

FIG. 16 is a flowchart illustrating an example of the process of Step S1405 in FIG. 14. The operations of the steps in the flowchart illustrated in FIG. 16 are sequentially performed by causing the CPU 103 which is a computer in the imaging apparatus to execute a computer program stored in a memory.

FIG. 17 is a diagram illustrating an example of a data range corresponding to an exposure determination time and a count threshold value according to the first embodiment.

In the flowchart illustrated in FIG. 16, first, the image processing unit 201 calculates a data range corresponding to the n-h exposure determination time and the count threshold value in Step S1601.

For example, in FIGS. 13 and 17, the exposure determination time with n=2 is T/N, and it can be seen from FIG. 13 that the count threshold value Cth at T/N is 32736 and the count maximum value Cmax is 523776. Accordingly, the corresponding data range ranges from 32736 to 523776 and shown in a histogram as illustrated in FIG. 17.

Then, in Step S1602, it is determined whether the pixel values in the n-th data range are saturated. That is, the image processing unit 201 determines whether the pixel values in the data range calculated in Step S1601 are saturated in the histogram calculated in Step S1403.

The process flow proceeds to Step S1603 when the pixel values are saturated, and the process flow proceeds to Step S1605 when the pixel values are not saturated. Whether the pixel values are saturated is determined by determining whether the number of pixels of which the pixel value is equal to or greater than a predetermined pixel value is equal to or greater than a predetermined number of pixels. That is, Step S1602 serves as a saturation determining step (a saturation determination unit) of determining the number of saturated pixels at the counted value for each determination time.

For example, when the number of effective pixels of the imaging device 102 is 1920×1080, the number of saturated pixels at 523776 which is the count maximum value Cmax is determined by determining whether the number of pixels of which the pixel value is equal to or greater than a predetermined pixel value (523776) is equal to or greater than a predetermined number of pixels (for example, 100).

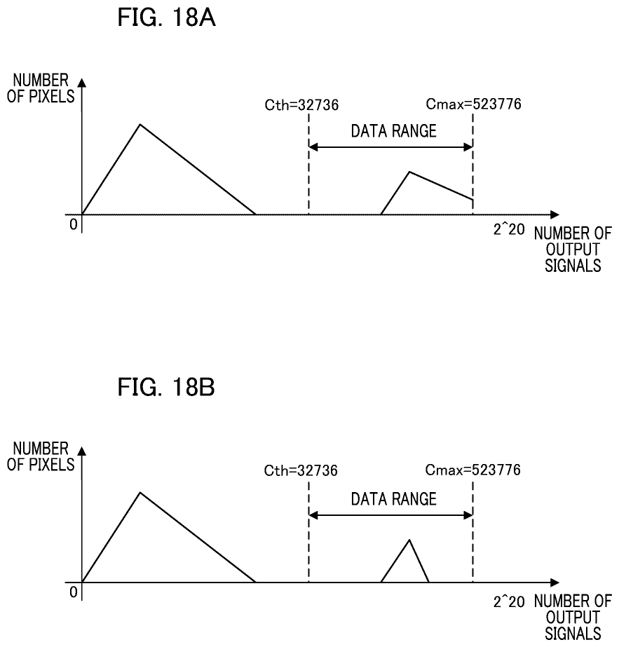

FIGS. 18A and 18B are diagrams illustrating an example of a histogram when the pixel value is saturated and when the pixel value is not saturated according to the first embodiment. The histogram when the pixel value is saturated is illustrated in FIG. 18A, and the histogram when the pixel value is not saturated is illustrated in FIG. 18B.

Here, the predetermined pixel value is set to 523776 which is the count maximum value corresponding to the exposure determination time, but may be set to a value smaller than the count maximum value. The predetermined number of pixels is not limited to 100, but may be another number and may be determined from a predetermined proportion with respect to the number of effective pixels of the imaging device 102.

Then, in Step S1603, the image processing unit 201 determines whether the n-th exposure determination time matches a lower-limit time. When it is determined that the n-th exposure determination time matches the lower limit, the flowchart illustrated in FIG. 16 ends, and the process flow proceeds to Step S1406 in FIG. 14. When it is determined in Step S1603 that the n-th exposure determination time does not match the lower limit, the process flow proceeds to Step S1604.

Here, the lower-limit time is a value which varies depending on the exposure determination times and which is the shortest settable time. As the lower-limit time of the exposure determination time becomes shorter, the acquirable data range becomes wider. For example, the lower-limit time may be set to 1/30000 when n=2, may be set to 1/15000 when n=1, and may be set to 1/7500 when n=0.

On the basis of proportions with respect to the maximum exposure time T which is a shutter speed, the lower-limit time may be set to T/1000 when n=2, may be set to T/500 when n=1, and may be set to T/250 when n=0.

Then, in Step S1604, the image processing unit 201 changes the n-th exposure determination time to a shorter time than the currently set time and stores information of the new exposure determination time in the RAM 108.

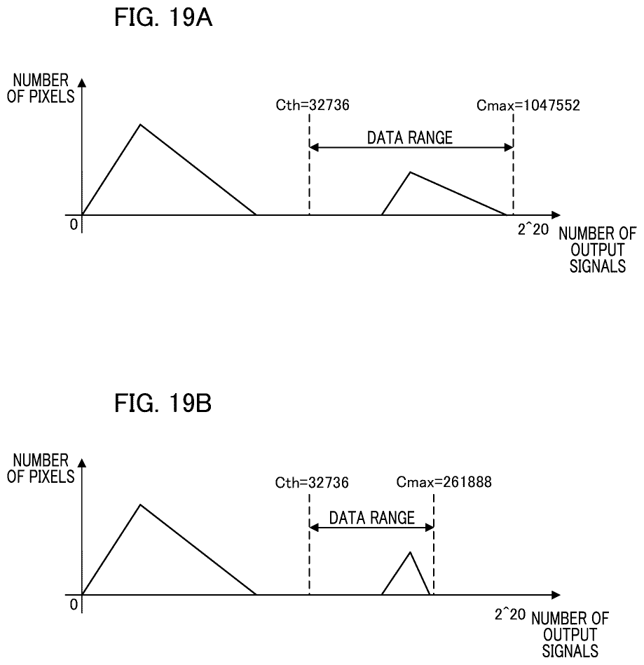

FIGS. 19A and 19B are diagrams illustrating an example of a data range after each exposure determination time has been changed according to the first embodiment. The exposure determination time may be stepwise changed to a shorter time to be closer to the lower-limit time or may be changed to the lower-limit time.

When the exposure determination time is changed to a shorter time, the acquirable data range becomes wider, and the data range in the histogram changes, for example, from FIG. 18A to FIG. 19A.

In Step S1605, the image processing unit 201 calculates a saturation level in the data range calculated in Step S1601 in the histogram calculated in Step S1403. At this time, for example, a tenth value when data of the histogram is arranged in the descending order in the data range from 32736 to 523776 calculated in Step S1601 is set as the saturation level.

Calculation of the saturation level is not limited to this method, and a value other than the tenth value may be used, or a value obtained by adding a predetermined value to a value at a predetermined position may be set as the saturation level.

Then, in Step S1606, the image processing unit 201 changes the n-th exposure determination time to a longer time than the currently set time on the basis of the saturation level calculated in Step S1606 and stores information of the new exposure determination time in the RAM 108.

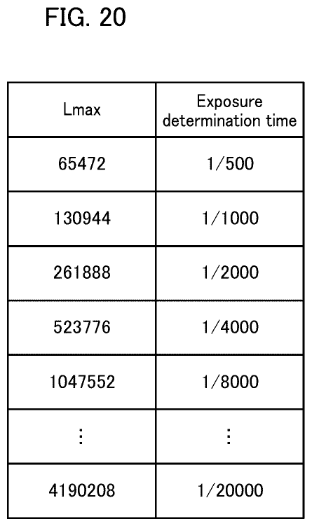

FIG. 20 is a diagram illustrating an example of table data of an exposure determination time corresponding to a count maximum value according to the first embodiment. For example, the number of output signals Nct when the number of input signals Nph is the count maximum value Cmax is defined as Lmax. Table data of the exposure determination time corresponding to Lmax as illustrated in FIG. 20 is stored in the ROM 107 or the RAM 108, and one exposure determination time is selected from the table data.

At this time, Lmax having the smallest value out of the values of Lmax greater than the saturation level is selected, and the exposure determination time corresponding to that Lmax is selected. For example, when the saturation level is 200000, 261888 is selected as Lmax in FIG. 20, and 1/2000 corresponding to that Lmax is selected as the exposure determination time.

In this case, the exposure determination time is changed to a longer time, and the acquirable data range is narrowed, for example, the data range in the histogram changes from FIG. 18B to FIG. 19B. Accordingly, it is possible to curb a decrease in gradation while securing the dynamic range of a subject.

As described above, the present embodiment, the determination time is controlled such that the number of saturated pixels is equal to or less than a predetermined number and the determination time increases.

In the present embodiment, the values Lmax and the exposure determination times illustrated in FIG. 20 are used as examples, but the present disclosure is not limited thereto, and other values may be used. Alternatively, the exposure determination time may be set to a value based on the maximum exposure time T which is a shutter speed, the corresponding Lmax may be calculated from the exposure determination time, and the table data may be changed. As the table data, table data varying depending on the exposure determination times may be used.

When the flowchart illustrated in FIG. 16 ends, the process flow proceeds to Step S1406 in FIG. 14. In Step S1406, the CPU 103 determines whether the variable n is less than nMax which is the maximum value of n. The process flow proceeds to Step S1407 when n is less than nMax, and the process flow proceeds to Step S1408 when n is not less than nMax.

In Step S1407, the image processing unit 201 calculates the (n+1)-th count threshold value and stores information of the calculated count threshold value in the RAM 108. For example, when nMax=2, the count threshold value is first calculated at n=1.

For example, it is assumed the first exposure determination time is calculated at n=1 and is the maximum value Lmax of the number of output signals Nct corresponding to the calculated exposure determination time. In this case, the second count threshold value is set to the number of input signals Nph in which the count threshold value is Lmax when it is converted to the number of output signals Nct.

Specifically, the number of input signals Nph which is obtained by substituting Lmax into the number of output signals Nct in Expression 2 and substituting the second exposure determination time into the exposure time T is used as the second count threshold value.

Accordingly, when the number of output signals Nct is less than Lmax, it is possible to acquire data with priority given to the first exposure determination time in comparison with the second exposure determination time and to curb a decrease in gradation. The example in which the (n+1)-th count threshold value matches the n-th Lmax has been described above, but the (n+1)-th count threshold value may be set to a value larger than the n-th Lmax.

In Step S1408, the CPU 103 determines whether the variable n is greater than 0. The process flow proceeds to Step S1409 when the variable n is greater than 0, and the process flow proceeds to Step S1411 when the variable n is not greater than 0.

In Step S1409, the image processing unit 201 calculates a reference of the (n−1)-th exposure determination time on the basis of the n-th exposure determination time calculated in Step S1606. For example, when the n-th exposure determination time is T/N and the (n−1)-th exposure determination time is T′, the reference is determined by Expression 3.

$${T}^{′} = T / {N}^{( n / ( n + 1 ) )} \qquad ( Expression 3 )$$

In this case, when the maximum exposure time which is a shutter speed is T and the second exposure determination time is T/512, N=512 and n=2, and thus the first exposure determination time is calculated as T/64.

Then, in Step S1410, the CPU 103 sets the variable n to n−1. After the process of Step S1410 has ended, the process flow proceeds to Step S1405, and the processes subsequent thereto are repeated.

On the other hand, in Step S1411, the n-th count threshold value is calculated. For example, the count threshold value is calculated as Cmax/N using the count maximum value Cmax of the number of input signals Nph and the n-th exposure determination time T/N.

Then, in Step S1412, the imaging device control unit 200 changes settings of the imaging device 102. Specifically, the exposure determination times and the count threshold values calculated in Steps S1405, S1407, and S1411 and stored in the RAM 108 are set in the imaging device 102.

Step S1412 also serves as a control step (a control unit) of controlling the determination time on the basis of the intensity distribution of light. In the present embodiment, a plurality of determination times are changed on the basis of the intensity distribution of light.

Here, the calculation process of Steps S1405, S1407, and S1411 and the settings changing process of Step S1412 may be performed at different timings or at intervals of different periods. For example, the calculation process and the settings changing process are performed in the same period, but information calculated in a previous period may be set in a next period. The settings changing process may be performed in a time period longer than that of the calculation process like performing the calculation process in a period of 1/30 seconds and performing the settings changing process in a period of 1 second.

In this way, in the present embodiment, the exposure determination times and the count threshold values with which a dynamic range is secured and a decrease in gradation is curbed are calculated on the basis of a histogram of a subject, and the settings are changed. Accordingly, it is possible to secure a very wide dynamic range and to curb a decrease in gradation.

### Second Embodiment

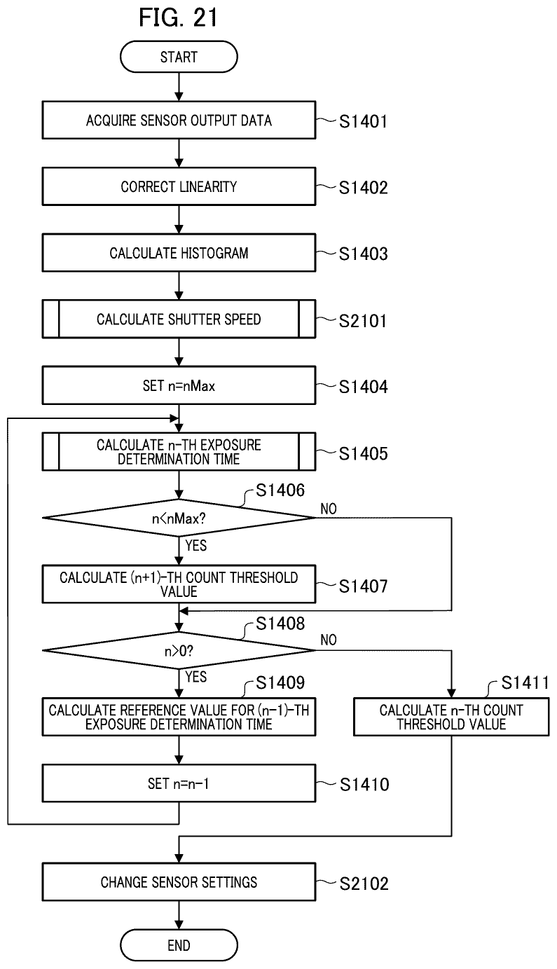

In a second embodiment, control of the maximum exposure time which is a shutter speed is additionally performed in addition to the configuration according to the first embodiment. The second embodiment will be described below with reference to FIGS. 21 to 24. Description of the same configuration in the second embodiment as in the first embodiment will be omitted.

FIG. 21 is a flowchart illustrating an example of a process flow of an imaging method in an imaging apparatus according to the second embodiment. The operations of the steps in the flowchart illustrated in FIG. 21 are sequentially performed by causing the CPU 103 which is a computer in the imaging apparatus to execute a computer program stored in a memory.

The same steps in the flowchart illustrated in FIG. 21 as in the flowchart illustrated in FIG. 14 are referred to by the same step numbers as in FIG. 14, and description thereof will be omitted. That is, in the flowchart illustrated in FIG. 21, the processes of Steps S1401 to S1403 are the same as the processes in FIG. 14, and thus description thereof will be omitted.

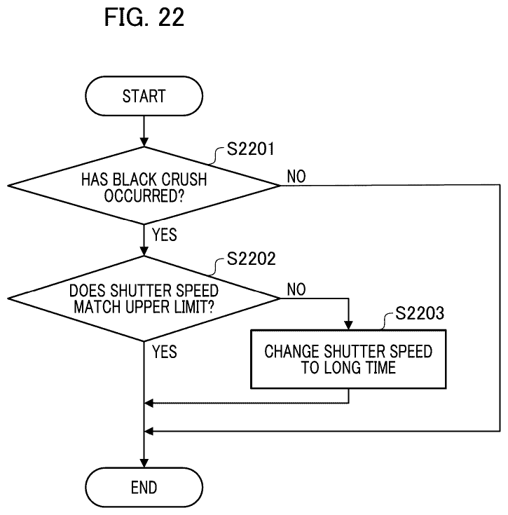

In Step S2101, the image processing unit 201 calculates the maximum exposure time which is a shutter speed. Step S2101 will be described with reference to the flowchart illustrated in FIG. 22.

FIG. 22 is a flowchart illustrating an example of a process of Step S2101 in FIG. 21. The operations of the steps in the flowchart illustrated in FIG. 22 are sequentially performed by causing the CPU 103 which is a computer in the imaging apparatus to execute a computer program stored in a memory.

In the flowchart illustrated in FIG. 22, first, the image processing unit 201 determines whether an image is black-crushed on the basis of the histogram calculated in Step S1403 in FIG. 21 in Step S2201.

The process flow proceeds to Step S2202 when an image is black-crushed, and the process flowchart illustrated in FIG. 22 ends and the process flow proceeds to Step S1404 in FIG. 21 when an image is not black-crushed. Here, Step S2201 serves as a block-crush determining step (a black-crush determining unit) of determining the number of black-crushed pixels based on the counted value.

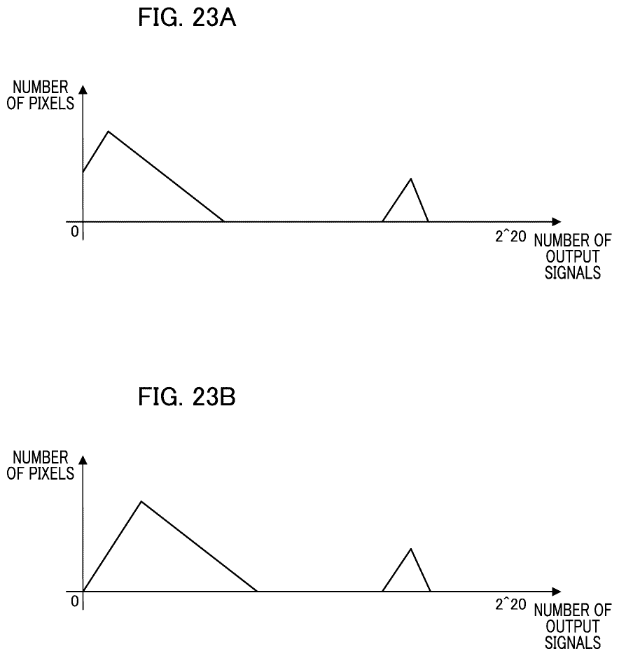

FIGS. 23A and 23B are diagrams illustrating an example of a histogram when an image is black-crushed and when an image is not black-crushed according to the second embodiment, where the histogram when an image is black-crushed is illustrated in FIG. 23A and the histogram when an image is not black-crushed is illustrated in FIG. 23B.

Whether an image is black-crushed is determined in Step S2201 by determining whether the number of pixels of which the pixel value is equal to or less than a predetermined pixel value is equal to or greater than a predetermined number of pixels. For example, when the number of effective pixels in the imaging device 102 is 1920×1080, the determination method includes determining whether the number of pixels of which the pixel value is equal to or less than 0 is equal to or greater than, for example, 100.

The predetermined pixel value may be set to a value greater than 0. The predetermined number of pixels is not limited to 100, but may be another number or may be set to a predetermined proportion with respect to the number of effective pixels in the imaging device 102.

Then, in Step S2202, the image processing unit 201 determines whether the maximum exposure time which is a shutter speed matches an upper-limit time. When the determination result is YES, the flowchart illustrated in FIG. 22 ends, and the process flow proceeds to Step S1404 in FIG. 21. When the determination result of Step S2202 is NO, the process flow proceeds to Step S2203. The upper-limit time in Step S2202 is the longest time of the maximum exposure times which are a shutter speed settable in the imaging apparatus 100.

In Step S2203, the image processing unit 201 changes the maximum exposure time which is a shutter speed to a longer time than the currently set time and stores information of the new shutter speed in the RAM 108.

That is, in Step S2203, the exposure time of the photoelectric conversion element is controlled such that the number of black-crushed pixels is equal to or less than a predetermined number. When the maximum exposure time which is a shutter speed has been changed to a longer time, the acquirable data range changes to a dark side, and the acquirable data range is widened.

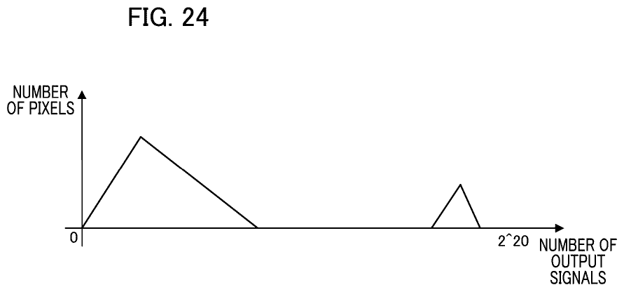

FIG. 24 is a diagram illustrating an example of a histogram after the maximum exposure time which is a shutter speed has been changed according to the second embodiment. When the maximum exposure time which is a shutter speed has been changed to a longer time in Step S2203, for example, the data range in the histogram changes from FIG. 23A to FIG. 24.

In Step S2203, the maximum exposure time which is a shutter speed may be stepwise changed to a longer time to be closer to the upper-limit time or may be changed to the upper-limit time. Steps S1404 to S1411 are the same as illustrated in FIG. 14.

Then, in Step S2102, the imaging device control unit 200 changes settings in the imaging device 102. Specifically, the maximum exposure time which is a shutter speed, the exposure determination times, and the count threshold values calculated in Steps S2101, S1405, S1407, and S1411 and stored in the RAM 108 are set in the imaging device 102.

Similarly to Step S1412 in FIG. 14, the calculation process of Steps S2101, S1405, S1407, and S1411 and the settings changing process of Step S2102 may be performed at different timings or at intervals of different periods.

In this way, according to the second embodiment, by calculating the maximum exposure time which is a shutter speed in which an image is not black-crushed on the basis of a histogram of a subject and changing the settings in addition to the configuration according to the first embodiment, it is possible to curb black crush in addition to the advantageous effects according to the first embodiment.

While the present disclosure have been described above in detail on the basis of preferable embodiments thereof, the present disclosure is not limited to the embodiments, and various modifications without departing from the gist of the present disclosure are included in the present disclosure. Some of the embodiments may be appropriately combined.

The present disclosure includes realization of the functions in the aforementioned embodiments, for example, using at least one processor such as a CPU, at least one memory, or at least one circuit (for example, an ASIC). The functions may be distributed and performed using two or more processors.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the imaging apparatus or the like through a network or various storage media. Then, a computer (or a CPU, an MPU, or the like) of the imaging apparatus or the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-023878, filed on Feb. 18, 2025, which is hereby incorporated by reference herein in its entirety.

What is claimed is:

1. An imaging apparatus comprising an imaging device including:
a counter configured to count the number of photons incident on a photoelectric conversion element;
an output unit configured to output information of the counted value of the counter and a predetermined determination time when the counted value reaches a predetermined threshold value in the determination time after the counter has started counting;
at least one processor; and
a memory coupled to the at least one processor, the memory storing instructions that, when executed by the at least one processor, cause the at least one processor to perform:
calculating an intensity distribution of light incident on pixels on the basis of the information of the counted value and the determination time output from the output unit; and
controlling the determination time on the basis of the intensity distribution of light.

2. The imaging apparatus according to claim 1, wherein the controlling of the determination time includes changing a plurality of determination times on the basis of the intensity distribution of light.

3. The imaging apparatus according to claim 1, wherein the memory stores further instructions that, when executed by the at least one processor, cause the at least one processor to perform:
determining the number of saturated pixels of the counted value for each determination time; and
controlling the determination time such that the number of saturated pixels is equal to or less than a predetermined number while the determination time increases.

4. The imaging apparatus according to claim 2, wherein a light intensity range acquirable for each determination time is calculated on the basis of the determination time and the predetermined threshold value, and the threshold value is calculated such that the light intensity range for each determination time does not overlap on the basis of the determination time and the light intensity range.

5. The imaging apparatus according to claim 1, wherein the memory stores further instructions that, when executed by the at least one processor, cause the at least one processor to perform:
determining the number of black-crushed pixels based on the counted value; and
controlling an exposure time of the photoelectric conversion element such that the number of black-crushed pixels is equal to or less than a predetermined number.

6. The imaging apparatus according to claim 1, wherein the output unit is configured to output the information on the counted value and the determination time as combined data for each pixel.

7. An imaging method that is performed using an imaging device including a counter configured to count the number of photons incident on a photoelectric conversion element and an output unit configured to output information of the counted value of the counter and a predetermined determination time when the counted value reaches a predetermined threshold value in the determination time after the counter has started counting, the imaging method comprising:
calculating an intensity distribution of light incident on pixels on the basis of the counted value and the determination time; and
controlling the determination time on the basis of the intensity distribution of light.

8. A non-transitory computer-readable storage medium configured to store a computer program to control an imaging device having a counter configured to count the number of photons incident on a photoelectric conversion element and an output unit configured to output information of the counted value of the counter and a predetermined determination time when the counted value reaches a predetermined threshold value in the determination time after the counter has started counting,
wherein the computer program comprises instructions for executing the following processes:
calculating an intensity distribution of light incident on pixels on the basis of the counted value and the determination time; and
controlling the determination time on the basis of the intensity distribution of light.
